(19) United States
(12) Patent Application Publication
(10) Pub. No.: US 2020/0125955 A1
(43) Pub. Date: Apr. 23, 2020

(54) EFFICIENTLY LEARNING FROM HIGHLY-DIVERSE DATA SETS

(71) Applicant: International Business Machines Corporation, Armonk, NY (US)

(72) Inventors: Tamir Klinger, Brooklyn, NY (US); Matthew D. Riemer, New York, NY (US); Clemens Rosenbaum, New York, NY (US); Bowen Zhou, Beijing (CN)

(21) Appl. No.: 16/168,266

(22) Filed: Oct. 23, 2018

(51) Int. Cl. G06N 3/08; G06N 3/04

(52) U.S. Cl. CPC G06N 3/084; G06N 3/0472

(57) ABSTRACT

Techniques for learning from highly-diverse datasets are provided. In one embodiment, the system is provided that comprises a memory that stores computer executable components. The system can comprise a processor that executes the computer executable components stored in the memory. The computer executable components can comprise a neural network component that creates a neural network comprising a router that routes the neural network to a first layer of neurons that comprises a plurality of neurons. The computer executable components can comprise a training component that performs a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

### BACKGROUND

The subject matter described herein relates to machine learning, and more specifically, to training a machine learning model with a diverse dataset.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, combinations of training a machine learning model with a diverse dataset are described.

According to an embodiment, a system is provided. In one or more examples, the system comprises a memory that stores computer executable components. In one or more implementations, the system can further comprise a processor that executes the computer executable components stored in the memory. In one or more implementations, the computer executable components can comprise a neural network component that creates a neural network comprising a router that routes the neural network to a first layer of neurons that comprises a plurality of neurons. In one or more implementations, the computer executable components can further comprise a training component that performs a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

In another embodiment, a method is provided. In one or more examples, the method comprises creating, by a system operatively coupled to a processor, a neural network comprising a router that routes the neural network to a first layer of neurons that comprises a plurality of neurons. In one or more examples, the method further comprises performing, by the system, a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

In another embodiment, a computer program product for training a neural network is provided. In one or more examples, the computer program product comprises a computer readable storage medium having program instructions embodied therewith. In one or more examples, the program instructions are executable by a processor to cause the processor to create, by the processor, the neural network comprising a router that routes the neural network to a first layer of neurons that comprises a plurality of neurons. In one more examples, the program instructions are executable by the processor to cause the processor to perform, by the processor, a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

### DESCRIPTION OF THE DRAWINGS

FIG. 1 illustrates an example, non-limiting routing network in accordance with one or more embodiments described herein.

FIG. 2 illustrates an example, non-limiting routing network, in which reinforcement learning (RL) is applied to the routing network of FIG. 1 in accordance with one or more embodiments described herein.

FIG. 3 illustrates three example, non-limiting router architectures in accordance with one or more embodiments described herein.

FIG. 4 illustrates an example, non-limiting routing network, in which different paths are taken for different tasks in accordance with one or more embodiments described herein.

FIG. 5 illustrates an example, non-limiting implementation of a routing layer where a router evaluates, selects, and applies a primitive from a neural network layer in accordance with one or more embodiments described herein.

FIG. 6 illustrates an example, non-limiting graph that plots the accuracy of different RL implementations for routers, such as the routers of FIG. 1 in accordance with one or more embodiments described herein.

FIG. 7 illustrates an example, non-limiting graph that plots the accuracy of different routing architectures, such as the routers of FIG. 3 in accordance with one or more embodiments described herein.

FIG. 8 illustrates an example, non-limiting graph of performance of a routing network and cross-stitch networks on a Canadian Institute for Advanced Research Multi-Task Learning (CIFAR-MTL) dataset in accordance with one or more embodiments described herein.

FIG. 9 illustrates an example, non-limiting graph of performance of a routing network and cross-stitch networks on a Mini-Imagenet Multi-Task Learning (MIN-MTL) dataset in accordance with one or more embodiments described herein.

FIG. 10 illustrates an example, non-limiting graph of performance of a routing network and cross-stitch networks on a Modified National Institute of Standards and Technology Multi-Task Learning (MNIST-MTL) dataset in accordance with one or more embodiments described herein.

FIG. 11 illustrates four example, non-limiting graphs of the training computation of routing networks and cross-stitch networks trained with various function blocks in accordance with one or more embodiments described herein.

FIG. 12 illustrates an example, non-limiting routing map for a MNIST-MTL dataset in accordance with one or more embodiments described herein.

FIG. 13 illustrates a flow diagram of an example, non-limiting computer-implemented method that facilitates efficiently learning from highly-diverse datasets in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A neural network (sometimes referred to as an artificial neural network) generally is a computer system that draws inspiration from an animal brain. In some examples, neural networks can learn to perform tasks by being provided with labeled data—e.g., to learn to identify a dog in a photo, a neural network may be provided with a dataset of photos, each photo labeled as depicting a dog or not depicting a dog.

Multi-task learning (MTL) with neural networks can leverage commonalities in tasks to improve performance, but can suffer from task interference, which reduces the benefits of transfer. In task interference, teaching a neural network to perform one particular task can interfere with the neural network's ability to perform a second particular task. A way to address task interference can involve utilizing a neural network and training approach referred to as a routing network paradigm.

A routing network generally is a kind of self-organizing neural network comprising two components: a router and a set of one or more function blocks. A function block can be any neural network—for example a fully-connected or a convolutional layer. In an example, given an input, the router makes a routing decision, choosing a function block to apply and passing the output back to the router recursively, terminating when a fixed recursion depth is reached. In this way the routing network dynamically composes different function blocks for each input. A collaborative multi-agent reinforcement learning (MARL) approach can be employed to jointly train the router and function blocks.

An effectiveness of the present techniques can be shown as compared with cross-stitch networks and shared-layer baselines on multi-task settings of a MNIST dataset, a mini-ImageNet dataset, and CIFAR-100 subset of a CIFAR-MTL dataset. Such a comparison can show a significant improvement in accuracy, with sharper convergence. In addition, routing networks can have a nearly constant per-task training cost while cross-stitch networks can scale linearly with the number of tasks. On a CIFAR-100 dataset (with 20 tasks), example experimental results indicate that cross-stitch performance levels can be obtained with an 85% reduction in training time.

MTL generally is a paradigm in which multiple tasks are learned simultaneously. Tasks are typically separate prediction problems, each with their own data distribution. A goal of MTL can be to improve generalization performance by leveraging domain-specific information contained in training signals of related tasks. This can mean that a model can leverage commonalities in the tasks (sometimes referred to as positive transfer) while minimizing interference (sometimes referred to negative transfer). An approach for training with the aid of positive transfer while minimizing negative transfer can be to use a routing network, which can comprise two trainable components: a router and a set of function blocks. In an example, given an input, the router can select a function block from the set, apply it to the input, and pass the result back to the router, recursively up to a fixed recursion depth. If the router determines to utilize fewer iterations, then it can take a PASS action, which leaves the current state unchanged. Such an architecture allows the network to dynamically self-organize in response to the input, sharing function blocks for different tasks when positive transfer is possible, and using separate blocks to prevent negative transfer.

This architecture can allow for many possible router implementations. For example, a router can condition its decision on both the current activation and a task label or just one or the other. A router can also condition on the depth (number of router invocations), filtering the function module choices to allow layering. In addition, a router can condition its decision for one instance on what was historically decided for other instances, to encourage re-use of existing functions for improved compression. In some examples, the function blocks can be simple fully-connected neural network layers or whole networks, where the dimensionality of each function block can allow composition with the previous function block choice. In some examples, the function blocks can be different types of layers. In some examples, any neural network or part of a network can be routed by adding its layers to the set of function blocks, making the architecture applicable to a wide range of problems. Because the routers can make a sequence of hard decisions, which are sometimes not differentiable, RL can be implemented to train the routers. One way to model this as a RL problem can be to create a separate RL agent for each task (where task labels are available in the dataset). Each such task agent can learn its own policy for routing instances of that task through the function blocks.

To evaluate, a routed version of a convolutional neural network (sometimes referred to as a convnet), and three image classification datasets adapted for MTL learning can be utilized: a multi-task MNIST dataset, a mini-ImageNet data split, and a CIFAR-100 dataset, where each of the 20 label superclasses are treated as different tasks. Experiments have been performed, comparing against cross-stitch networks, and an approach of joint training with layer sharing. Results indicate a significant improvement in accuracy over these baselines with a speedup in convergence, and often orders of magnitude improvement in training time over cross-stitch networks.

Work on multi-task deep learning traditionally includes significant hand design of neural network architectures, attempting to find the right mix of task-specific and shared parameters. For example, many architectures share low-level features like those learned in shallow layers of deep convolutional networks, or word embeddings across tasks and add task-specific architectures in later layers. By contrast, in routing networks, a fully dynamic, compositional model can be learned, which can adjust its structure differently for each task.

Routing networks can share a goal with techniques for automated selective transfer learning using attention, and learning gating mechanisms between representations. In the latter approach, experiments have been performed on two tasks at a time. Up to 20 tasks are considered in the experiments.

The present techniques can have commonalities with mixtures of experts architectures, as well as their modern attention based, and sparse, variants. The gating network in a typical mixtures of experts model takes in the input and chooses an appropriate weighting for the output of each expert network. This is generally implemented as a soft mixture decision as opposed to a hard routing decision, allowing the choice to be differentiable. Although a sparse and layer-wise variant can save some computational burden, an end-to-end differentiable model is only an approximation and does not model important effects such as exploration vs. exploitation tradeoffs, despite their impact on the system. Mixtures of experts have been considered in the transfer learning setting, however, the decision process is modelled by an autoencoder-reconstruction-error-based heuristic and is not scaled to a large number of tasks.

In the use of dynamic representations, the present techniques can have commonalities with single task and multi-task models that learn to generate weights for an optimal neural network. While these models can be powerful, they have trouble scaling to deep models with a large number of parameters without tricks to simplify the formulation. In contrast, embodiments of the present techniques show that routing networks can be applied to create dynamic network architectures for architectures like convnets by routing some of their layers.

The present techniques can apply automated architecture search to MTL. In automated architecture search, a goal can be to reduce the burden on the practitioner by automatically learning black box approaches that search for optimal architectures and hyperparameters. With the present techniques, a very general class of architectures can be constructed without the need for human intervention to manually choose which parameters will be shared and which will be kept task-specific.

The present techniques can also relate to minimizing computation cost for single-task problems by conditional routing. This includes decisions trained with a reinforce, a Q-Learning, and/or an actor-critic approach. A reinforce approach is sometimes referred to as an RL approach or a REINFORCE approach, and can generally refer to an approach where, if an action such as a routing decision is made that results in a reward, then the reward can be used to reinforce the likelihood of taking that action again in a similar circumstance. The present techniques can differ in the introduction of several novel elements. Specifically, the present techniques can involve a MTL setting, using a multi-agent reinforcement learning training approach, and can be structured as a recursive decision process.

In some examples, a routing network can use two kinds of rewards: immediate action rewards rᵢ given in response to an action aᵢ, and a final reward r_{final}, given at the end of the routing. The final reward can be a function of the network's performance. In some examples, for classification problems discussed herein, the final reward can be set to +1 if the prediction was correct (y\hat{ }=y), and −1 otherwise. In some examples, for other domains, such as regression domains, the negative loss (−L(y\hat{ }, y)) could be used.

In some examples, an immediate reward that encourages the router to use fewer function blocks when possible can be determined experimentally. In some examples where the number of function blocks per-layer needed to maximize performance is not known ahead of time (e.g., it can be assumed to be the same as the number of tasks), an analysis of whether comparable accuracy can be achieved while reducing the number of function blocks ever chosen by the router can be performed, which can allow for reducing a size of the network after training. In some experiments, two different rewards are analyzed, multiplied by a hyper-parameter ρ ∈ [0, 1]: the average number of times that block was chosen by the router historically and the average historical probability of the router choosing that block. Some experiments show no significant difference between the two approaches, and average probability can generally be used in the present techniques.

Routing networks can be composed of an alternating sequence of routers and routing layers. A routing layer itself can contain neural networks. These can be small units such as Rectified Linear Units (ReLUs). A router can be a component that makes a routing decision, sending its input to exactly one network in the next routing layer. A first router can send the network input to a single network in the first routing layer; the second router can send the output of that model (applied to the input) to a single network in the second layer; and so on. Both the routing layer networks and the routers can be trained jointly using the stochastic gradient descent approach and policy gradient reinforcement learning in such a way as to encourage the network to reuse existing paths where possible.

Specifically, when there are N tasks to be learned, N agents can be created, each assigned to make routing decisions for one task. The policy learned from these agents can be used by each router when presented with an instance for that task. In this view, training a routing network can be a cooperative multi-agent reinforcement learning problem. To train the network on an instance x with label y from a dataset, the instance can be input to the network and each router can decide about the model in the subsequent layer which will be applied next. The final output y′ from the network can then be compared to the ground truth label y and a loss function is applied. The models selected at each layer of the network can then be trained using stochastic gradient descent and backpropagation. The routing agents can each be trained using a reinforce learning approach. This reinforce approach can train the agent's policy according to a reward or penalty. A reward can be supplied if the model correctly predicted the label (i.e., y′=y) and a penalty in the case where it is different. This is called a performance reward. To further encourage the agents to cooperate and re-use models where possible, another reward can be supplied, called a compression reward, which is positive when routing decision being made has historically been made by other agents in the past. This can encourage agents to cooperate in training the models in each routing layer to be useful across tasks, further enhancing transfer. In this way the agents can make independent decisions which are trained to maximize the dual objectives of overall accuracy and efficiency.

The following example describes how a routing network can be trained on a dataset that can comprise multiple tasks (e.g., a multi-task learning scenario). The present techniques can be applied in other supervised training settings, such as a fewshot scenario (where there are few classes and little data per class), or a life-long learning scenario (where an unbounded sequence of training datasets of arbitrary size can be presented to the trainer one at a time in sequence).

In some examples, the following approach can be used to train a routing network, as further discussed with regard to the present techniques:

1. Initialize the routing layer models randomly

2. Create an RL Agent for each task, with a separate policy network for each routing layer. This Agent can determine the router selection function.

3. Make a forward pass through the network:

4. For each routing layer 1, do:

5. Pass the partial evaluation (f₁(f₂ . . . (x) . . . )) to the 1th Router, and compute the policy π₁

6. Choose a Routing Layer f₁( . . . ) following in

7. Assemble a network N (f₁(f₂ . . . (fₙ(x) . . . )), and do a prediction

8. Compute the loss for this network on N, as if it was a monolithic network from the start

9. Train the selected Subnets using stochastic gradient descent (SGD)/backpropagation

10. Train the selected Routers using a reinforce learning approach with a reward if the model successfully classified the input instance (performance reward) and a separate reward for routers that select an action that has historically been selected by other Agents (compression reward). The ratio between the performance and compression rewards can be controlled by a hyper-parameter factor that itself can be learned using a search approach and a validation set.

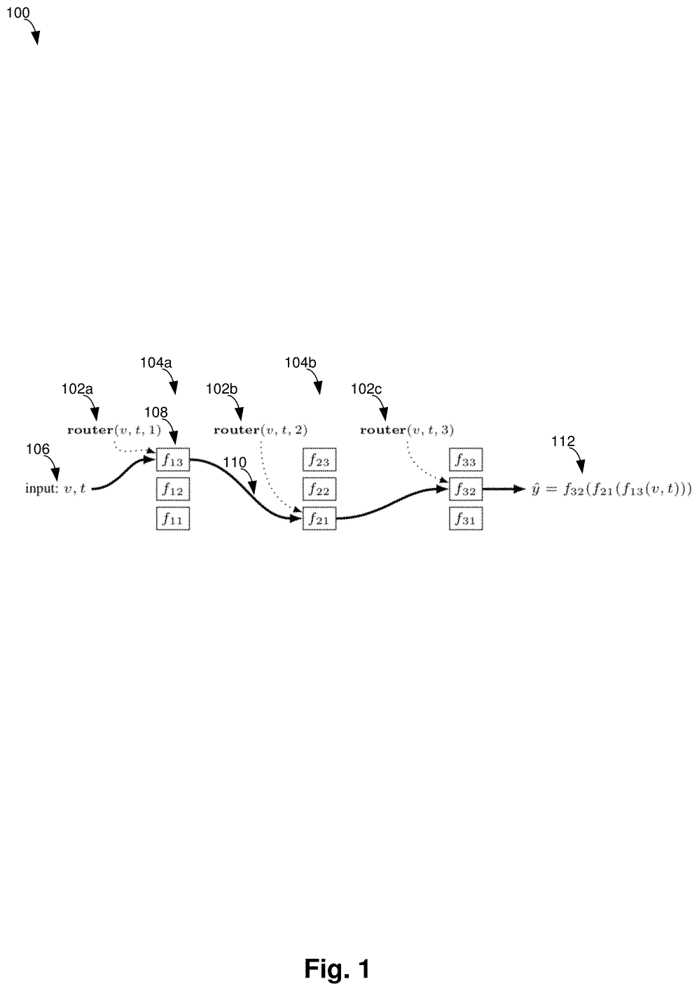

FIG. 1 illustrates an example, non-limiting routing network 100 in accordance with the present techniques. A routing network similar to routing network 100 can comprise two components: a router (e.g., router 102a) and a set of function blocks (e.g., set of function blocks 108), each of which can be any neural network layer, in some examples. Router 102a can be a function that selects from among the function blocks 108 given some input 106. Routing, such as performed by router 102a, generally is the process of iteratively applying a router to select a sequence of function blocks to be composed and applied to the input vector. The input 106 to the routing network 100 can be an instance to be classified (v, t), where v ∈ Rd is a representation vector of dimension d and t is an integer task identifier. The router 102a can be given v, t and a depth (=1), the depth of the recursion, and select from among a set of function block 104a choices available at depth 1, {f₁₃, f₁₂, f₁₁}, picking f₁₃ 108 which is indicated with a dashed line. f₁₃ 108 can be applied to the input (v, t) 106 to produce an output activation 110.

The router (depicted here logically as router 102b, though there can be embodiments where router 102a and router 102b are the same) can again choose a function block from those available at depth 2 104b (where the function blocks are of different dimensions, then the router can be constrained to select dimensionally matched blocks to apply) and so on. The router (depicted here logically as router 102c, though there can be embodiments where router 102c, router 102b, and/or router 102b are the same) can choose a function block from the last (classification) layer function block set 104c and produce the classification y\hat{ } 112.

In some examples, the routing approach taken by routing network 100 can be expressed using the following pseudocode:

```
      input: x,t,n:
            x ϵ R^{d}, d the representation dim;
            t integer task id;
      n max depth
      output: v - the vector result of applying the composition of the
selected functions to the input x
      1 v←x
      2 for i in 1...n do
      3  a ← router(x, t, i)
      4  if a/= PASS then
      5  x ← function blocka(x)
      6 return ν
```

This approach can take as input a vector v, task label t and maximum recursion depth n. The process can iterate n times, choosing a function block on each iteration and applying it to produce an output representation vector. A special PASS action can skip to the next iteration. In some experiments, a task label is optional, and in such examples, a dummy value can be passed. For simplicity in some examples, it can be assumed that the process has access to the router function and function blocks, and the process does not include them explicitly in the input. The router decision function router: Rd×Z+×Z+→{1,2, . . . ,k,PASS} (for d the input representation dimension and k the number of function blocks) can map the current representation v, task label t ∈ Z+, and current depth i ∈ Z+ to the index of the function block to route next in the ordered set function block.

Regarding a PASS action, when routing networks, some resulting sets of function blocks can be applied repeatedly. While there might be other constraints, the prevalent one can be dimensionality—input and output dimensions need to match in some embodiments. Applied to a SimpleConvNet architecture, this can mean that of the fc layers—(convolution→48), (48→48), (48→#classes)—the middle transformation can be applied an arbitrary number of times. In this case, the routing network can become fully recurrent and the PASS action is applicable. This can allow the network to shorten the recursion depth.

In examples where the routing network is run for d invocations, then it can be said that the router has depth d. For N function blocks, a routing network run to a depth d can select from Nd distinct trainable functions (the paths in the network). In some examples, any neural network can be represented as a routing network by adding copies of its layers as routing network function blocks. The function blocks for each network layer can be grouped, and the router can be constrained to pick from layer 0 function blocks at depth 0, layer 1 blocks at depth 1, and so on. In some examples, if the number of function blocks differs from layer to layer in the original network, then the router can accommodate this by, for example, maintaining a separate decision function for each depth.

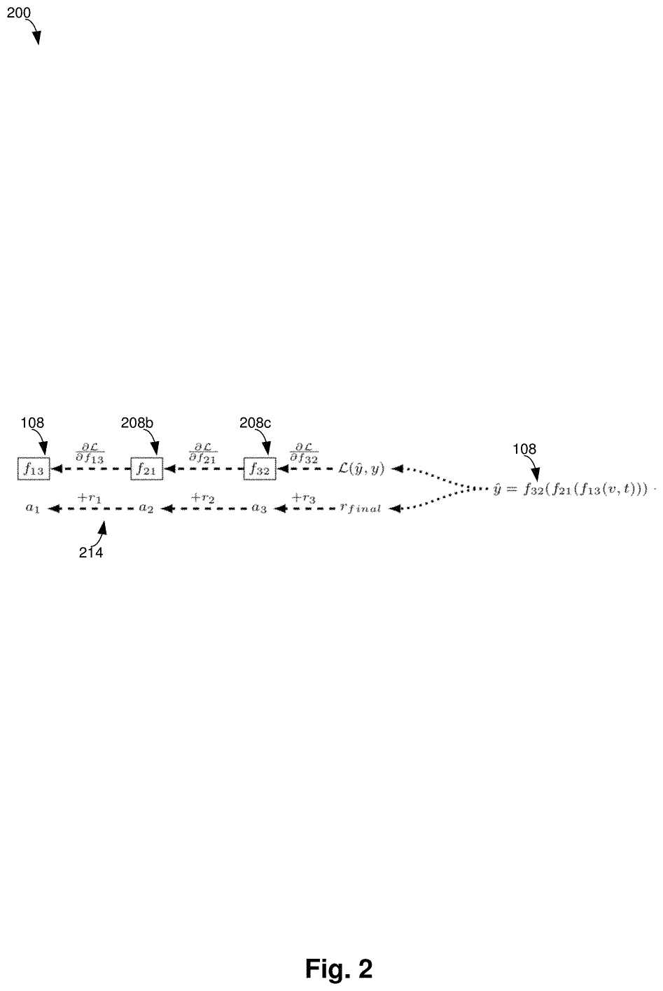

FIG. 2 illustrates an example, non-limiting routing network 200, in which RL is applied to routing network 100 of FIG. 1. Routing can be viewed as an RL problem in a following way. The states of a Markov Decision Process (MDP) can be the triples (v, t, i) where v ∈ Rd is a representation vector (initially the input), t is an integer task label for v, and i is the depth (initially 1). The actions can be function block choices (and PASS) in {1, . . . k, PASS} fork the number of function blocks. Given a state s=(v, t, i), the router can make a decision about which action to take. For the non-PASS actions, the state can then be updated s′=(v′, t, i+1) and the process can continue. The PASS action can produce the same representation vector again but increment the depth, so s′=(v, t, i+1). The router policy can be trained using a variety of RL approaches and settings, some of which are described with regard to the present techniques.

In some examples, independent of the RL approach applied, the router and function blocks can be trained jointly. For example, in each instance the instance can be routed through the network to produce a prediction y″. Along the way, a trace of the states sᵢ and the actions aᵢ taken can be recorded, as well as an immediate reward rᵢ for action aᵢ. When the last function block is chosen, a final reward can be rewarded, which can depend on the prediction y″ and the true label y.

In some examples, the selected function blocks can be trained using SGD or back propagation (sometimes referred to as backprop). In the example of FIG. 1, this can mean computing gradients for the function blocks that are selected. The computed trace can then be used to train the router using an RL approach. An example of this at a high-level can be expressed using the following pseudocode:

input: A dataset D of samples (v, t, y), v the input representation, t an integer task label, y a ground-truth target label
1 for each sample s=(v,t,y) ∈ D do
2 Do a forward pass through the network, applying the pseudocode described with respect to FIG. 1 to sample s.
3 Store a trace T=(S,A,R,r_{final}), where S=sequence of visited states (sᵢ); A=sequence of actions taken (aᵢ); R=sequence of immediate action rewards (rᵢ) for action aᵢ; and the final reward r_{final}. The last output as the network's prediction y\hat{ } and the final reward r_{final} is +1 if the prediction y\hat{ } is correct; −1 if not.
4 Compute the loss L(y\hat{ }, y) between prediction y\hat{ } and ground truth y and backpropagate along the function blocks on the selected route to train their parameters.
5 Use the trace T to train the router using the desired RL training approach.

To keep the presentation uncluttered, it can be assumed that the RL training approach has access to the router function, function blocks, loss function, and specific hyper-parameters such as discount rate that are utilized for the training, and these are not explicitly included in the input.

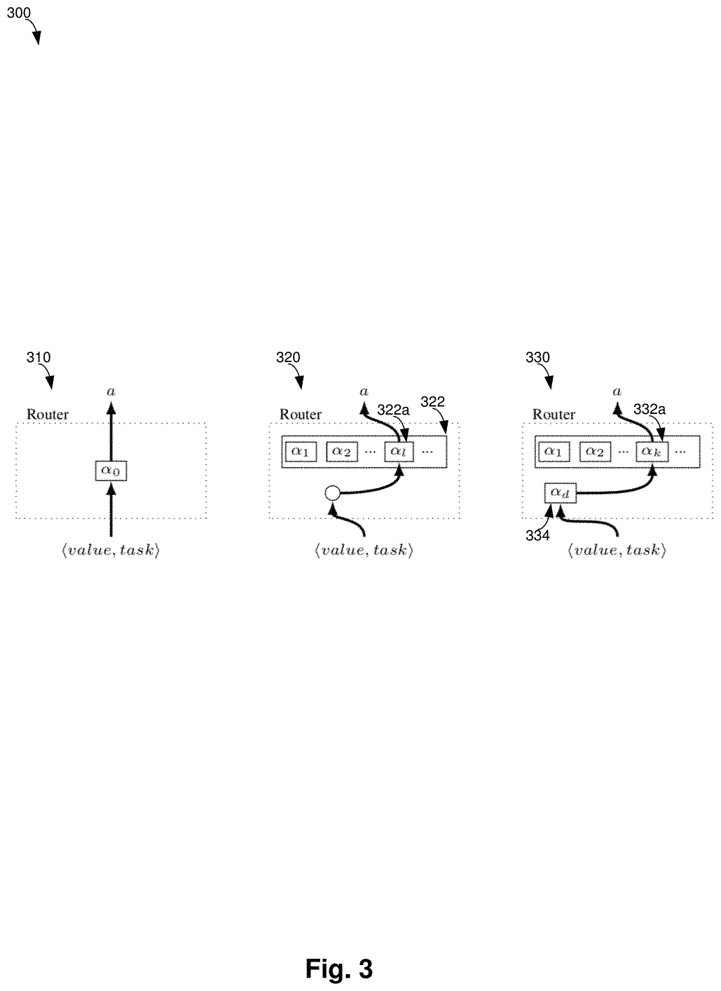

FIG. 3 illustrates three example, non-limiting router architectures 300. In embodiments, aspects of one or more of router 310, router 320 and router 330 can be used to implement router 102a, router 102b, and/or router 102c of FIG. 1.

In some examples, to train a router, both single-agent and multi-agent RL strategies can be evaluated. FIG. 3 shows three variations of approaches to train a router. In the example of router 310, there is a single agent that makes the routing decision. This can be trained using either policy-gradient (PG) or Q-Learning approaches. Router 320 shows a multi-agent approach. Here, there is depicted a fixed number of agents 322 and a hard rule that assigns the input instance to an agent responsible for routing it 322a. In experiments, one agent per task is created and used the input task label as an index to the agent responsible for routing that instance. Router 330 shows a multi-agent approach in which there is an additional agent, denoted ad 334 and called a dispatching agent, which learns to assign the input to an agent, instead of using a fixed rule. For both of these multi-agent scenarios of router 320 and router 330, additionally experiments can be performed with a MARL approach called Weighted Policy Learner (WPL).

In some examples, the policy can be stored as a table, or in form of an approximator. A tabular representation can have an invocation depth as its row dimension and a function block as its column dimension, with the entries containing the probability of choosing a given function block at a given depth. An approximator representation can entail one MLP that is passed the depth (represented in 1-hot), or a vector of d MLPs, one for each decision/depth, for example.

In some examples, both the Q-Learning and Policy Gradient approaches can be used with tabular and approximation function policy representations. A reinforce gradient approach (sometimes referred to as a reinforce learning approach) can be used to train both the approximation function and tabular representations. For Q-Learning, the table can store the Q-values in the entries. Plain Q-Learning can be used to train tabular representation and train the approximators to minimize a 12 norm of a temporal difference error.

Implementing a router decision policy using multiple agents (such as with router 320 and router 330) can turn a routing problem into a stochastic game, which can be a multi-agent extension of a MDP. In stochastic games, multiple agents can interact in the environment, and the expected return for any given policy may change without any action on that agent's part. In such a scenario, incompatible agents can compete for blocks to train, since negative transfer can make collaboration unattractive, while compatible agents can gain by sharing function blocks. The agent's (locally) optimal policies can correspond to the game's Nash equilibrium.

For routing networks, the environment can be considered to be non-stationary, since the function blocks can be trained as well as a router policy. Single-agent policy gradient methods such as a reinforce learning approach can be utilized, in some circumstances can be well adapted to the changing environment and changes in other agent's behavior, which can degrade their performance in this setting.

One MARL approach that can address this problem, and which can converge in non-stationary environments, is a WPL approach. A WPL approach can be expressed with the following example pseudocode:

```
input: A trace T = (S,A,R,rfinal) n the maximum depth;
      R\hat{ }, the historical average returns (initialized to 0 at the start of
training);
      γ the discount factor; and
      λ_{π} the policy learning rate
output: An updated router policy π
1  for each action aᵢ ϵ A do
2  Compute the return:
3  Rᵢ ← r_{final} + Σⱼ₌ᵢⁿ γ^{j-i}rⱼ − i
4  Update the average return:
5  R\hat{ }ᵢ ← (1 − λπ)R\hat{ }ᵢ + λ_{π}Rᵢ
6  Compute the gradient:
7  Δ(aᵢ) ← Rᵢ − R\hat{ }ᵢ
8  Update the policy:
9  if Δ(aᵢ) < 0 then
10  Δ(aᵢ) ← Δ(aᵢ)(1 − π(aᵢ))
11  else
12  Δ(aᵢ) ← Δ(aᵢ)
13 π ← simplex-projection(π + λ_{π}Δ)
```

WPL generally is a PG approach designed to dampen oscillation and push the agents to converge more quickly. This can be done by scaling the gradient of the expected return for an action, a, according the probability of taking that action π(a) (if the gradient is positive) or 1−π(a) (if the gradient is negative). This can have the effect of slowing down the learning rate when the policy is moving away from a Nash equilibrium strategy, and increasing it when it approaches one. In some examples, it can be assumed that the historical average return R\hat{ }ᵢ for each action aᵢ is initialized to 0 before the start of training. The function simplex-projection can project the updated policy values to make it a valid probability distribution.

In this example, the projection is defined as: f(π)/(f(π)), where f(x)=max(0, min(1, x)). The states, S. in the trace are not used by the example WPL approach.

A WPL approach generally is a multi-agent policy gradient approach that is designed to help dampen policy oscillation and encourage convergence. It can do this by slowly scaling down the learning rate for an agent after a gradient change in that agents policy. It can determine when there has been a gradient change by using the difference between the immediate reward and historical average reward for the action taken. Depending on the sign of the gradient, the approach can be in one of two scenarios. If the gradient is positive then it can be scaled by 1−πn(aᵢ). Over time if the gradient remains positive it can cause π(aᵢ) to increase, and so 1−πn(aᵢ) can go to 0, slowing the learning. If the gradient is negative then it can be scaled by π(aᵢ). Here again if the gradient remains negative over time it can cause π(aᵢ) to decrease eventually to 0, slowing the learning again. Slowing the learning after gradient changes can dampen the policy oscillation and helps drive the policies towards convergence.

In some examples, the training of the router and function blocks can be performed independently after computing the loss. In some examples, the gradients from the router choices, Δ(aᵢ), can be added to those for the function blocks which produce their input.

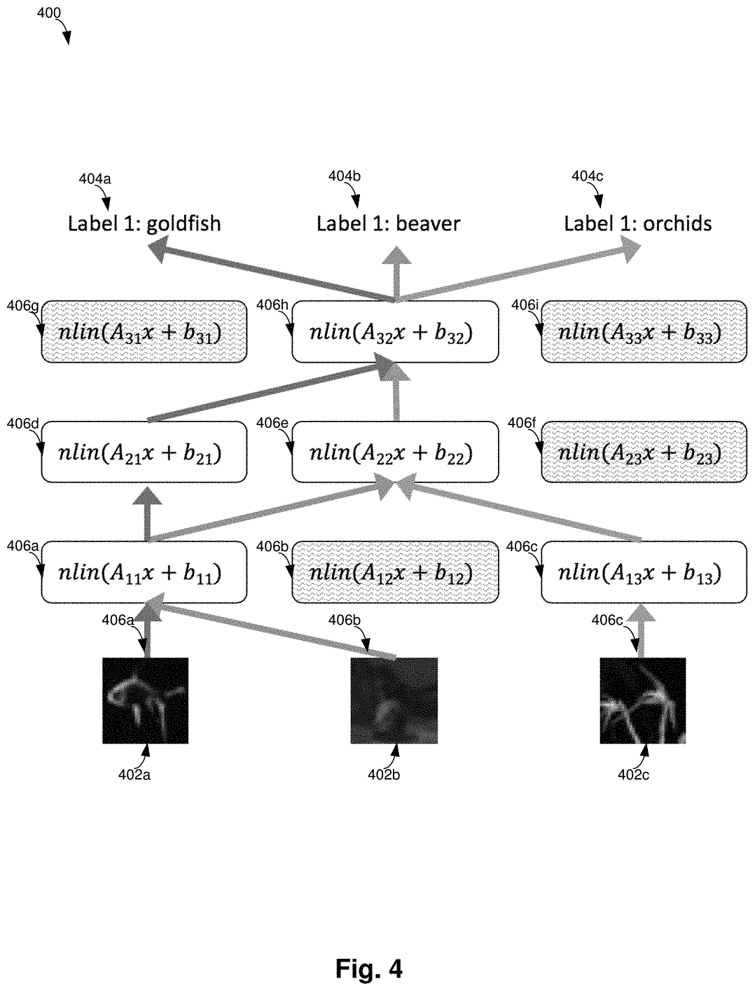

FIG. 4 illustrates an example, non-limiting routing network 400, in which different paths are taken for different tasks. In some examples, router 310, router 320, and/or router 330 can be implemented to effectuate a routing network such as routing network 400.

In routing network 400, three inputs are provided—input 402a, input 402b, and input 402c. In this example, the inputs are images, and the task performed by routing network 400 is to label the input with a description of what the respective photo depicts—label 404a, label 404b, and label 404c. As depicted, input 402a corresponds to label 404a, input 402b corresponds to label 404b, and input 402c corresponds to label 404c.

Routing network 400 is depicted as comprising nine neurons—neuron 408a, neuron 408b, neuron 408c, neuron 408d, —neuron 408e, neuron 408f, neuron 408g, neuron 408h, and neuron 408i. As depicted, routing network 400 processes each of input 402a, input 402b, and input 402c with a different path through routing network 400. The path 406a for processing input 402a goes though neuron 408a, then neuron 408d, then neuron 408h. The path 406b for processing input 402b goes though neuron 408a, then neuron 408e, then neuron 408h. The path 406a for processing input 402a goes though neuron 408c, then neuron 408e, then neuron 408h. As depicted, neuron 408b, neuron 408f, neuron 408g, and neuron 408i are not utilized as a path for processing these inputs.

As can be seen by the example of routing network 400, at some layers of a routing network, different inputs can be processed with the same neuron (e.g., neuron 408h is used to process input 402a, input 402b, and input 402c). And at some layers of a routing network, different inputs can be processed with different neurons (e.g., neuron 408a is used to process input 402a and input 402b, but neuron 408c is used to process input 402c).

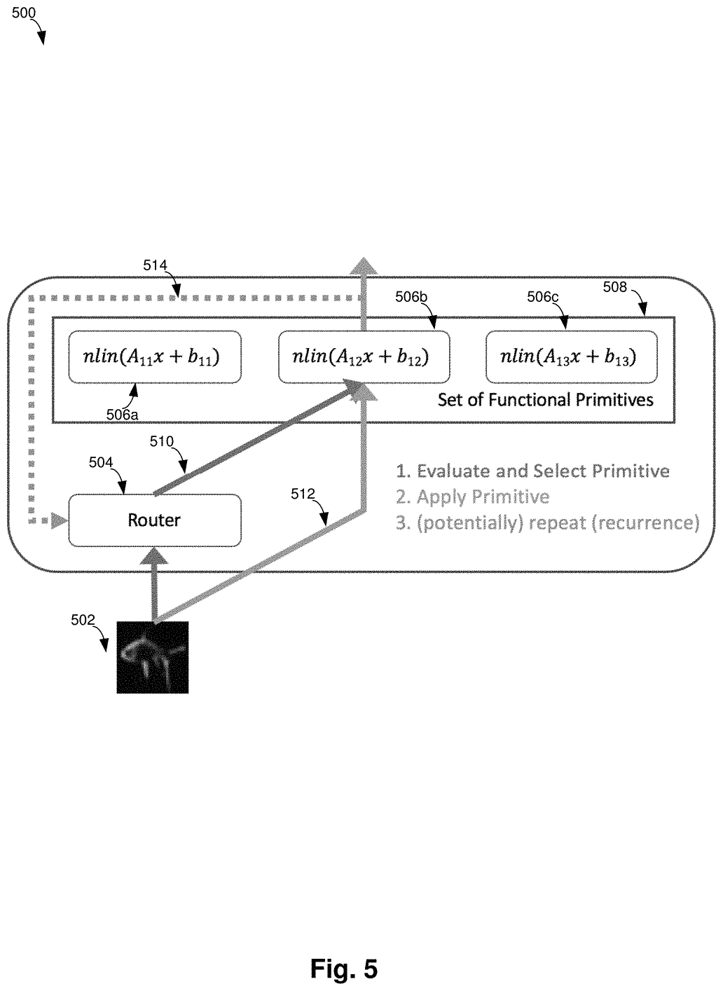

FIG. 5 illustrates an example, non-limiting implementation of a routing layer 500 where a router evaluates, selects, and applies a primitive from a neural network layer.

Routing layer 500 comprises input 502, router 504, set of functional primitives 508 (comprising neuron 506a, neuron 506b, and neuron 506c), evaluate and set primitive path 510, apply primitive path 512, and repeat path 514. When given input 502, router 504 can evaluate input 502 and determine to process input 502 with neuron 506b (from among the neurons of set of functional primitives 508), as indicated by evaluate and select primitive path 510. Router 504 can process input 502 with that selected neuron—neuron 506b—as indicated by apply primitive path 512. The process can be repeated, as indicated by repeat path 514

Two approaches can be combined to accomplish what is depicted in routing layer 500. Stochastic gradient descent with back propagation can be used to adjust parameters in neurons, such as neuron 506b. RL (e.g., a weighted-policy learner) can be utilized for training router 504.

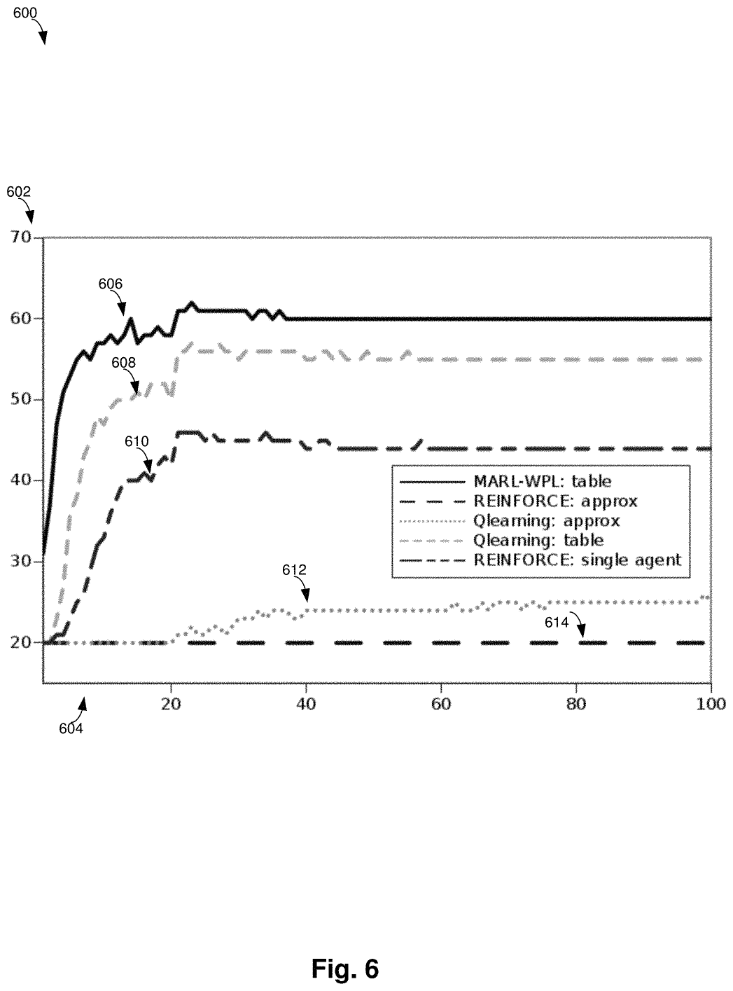

FIG. 6 illustrates an example, non-limiting graph 600 that plots the accuracy of different RL implementations for routers, such as router 102a, router 102b, or router 102c of FIG. 1. In graph 600, the Y-axis 602 represents accuracy as expressed in a percentage, while the X-axis 604 represents a number of epochs. Results are plotted for MARL-WPL (table) 606, Q-Learning (table) 608, reinforce learning (single agent) 610, Q-Learning (approximate) 612, and reinforce learning (approximate) 614.

In examples, three datasets are used to determine quantitative results: multi-task versions of MNIST-MTL, MIN-MTL, and CIFAR-100 datasets, where the 20 superclasses can be treated as tasks. In the binary MNIST-MTL dataset, the task can be to differentiate instances of a given class c from non-instances. 10 tasks can be created, and for each, 1,000 instances of the positive class c, and 1,000 each of the remaining 9 negative classes can be used, for a total of 10,000 instances per task during training, which we then test on 200 samples per task (2,000 samples in total). A MIN-MTL dataset generally is a smaller version of an ImageNet dataset, so can be easier to train in reasonable time periods. For mini-ImageNet, 50 labels can be randomly chosen, and tasks can be created from 10 disjoint random subsets of five labels each chosen from these. Each label can have 900 training instances and 50 testing instances—so 4,000 training and 250 testing instances per task. For all 10 tasks, there can be a total of 40,000 training instances. Finally, a CIFAR-100 dataset can have coarse and fine labels for its instances. One task can be created for each of the 20 coarse labels, and 500 instances can be included for each of the corresponding fine labels. There can then be 20 tasks with a total of 2,500 instances per task; 2,500 for training and 500 for testing. In these examples, results are reported on the test set and are averaged over 3 runs.

Each of these example datasets can have characteristics that challenge the learning in different ways. A CIFAR-MTL dataset can be considered to be a “natural” dataset, where tasks correspond to human categories. A MIN-MTL dataset can be randomly generated, so can have less task coherence. This can make positive transfer more difficult to achieve and negative transfer more of a problem. And a MNIST-MTL dataset, while it can be simple, can have a property that the same instance can appear with different labels in different tasks, causing interference. For example, in the “0 vs other digits” task, “0” can appear with a positive label but in the “1 vs other digits” task it can appear with a negative label.

These example experiments are conducted on a convnet architecture (SimpleConvNet). This example model has four convolutional layers, each comprising a 3×3 convolution and 32 filters, followed by batch normalization and a ReLU. The convolutional layers in this example are followed by three fully connected layers, with 128 hidden units each. The routed version of the example network routes the three fully connected layers, and for each routed layer, supplies one randomly initialized function block per task in the dataset. When neural net approximators are used for the router agents, they can be two layer MLPs with a hidden dimension of 64. A state (v,t,i) can be encoded for input to the approximator by concatenating v with a 1-hot representation oft (if used). That is, encoding(s) =concat(v, one hot(t)).

A parameter sweep can be utilized to find a chosen learning rate and p value for each approach on each dataset. p=0.0 (no collaboration reward) can be used for CIFAR-MTL and MIN-MTL datasets, and p=0.3 can be used for a MNIST-MTL dataset. The learning rate can be initialized to 10⁻² and annealed by dividing by 10 every 20 epochs. SGD can be utilized. The SimpleConvNet can have batch normalization layers, and no dropout can be used as well.

For one experiment, a special PASS action can be dedicated to allow the agents to skip layers during training, which can leave the current state unchanged (routing-all-fc recurrent/+PASS).

In a first experiment, shown in graph 600, different RL training approaches can be compared on a CIFAR-MTL dataset. In the examples described, five approaches are compared: MARL:WPL 606; a single agent reinforce learning approach (sometimes referred to as a reinforce learner) with a separate approximation function per layer 610; an agent-per-task reinforce learning approach that maintains a separate approximation function for each layer 614; an agent-per-task Q-learner with a separate approximation function per layer 612; and an agent-per-task Q-learner with a separate table for each layer 608. In the experimental results the WPL approach 606 is found to perform best, which outperforms the nearest competitor, tabular Q-Learning 608 by about 4%. It can be observed from experimental results that, (1) the WPL approach 606 can work better than a similar vanilla PG, which can have trouble learning; (2) having multiple agents can work better than having a single agent; and (3) the tabular versions, which use the task and depth to make their predictions, can work better here than the approximation versions, which can use the representation vector in addition predict the next action.

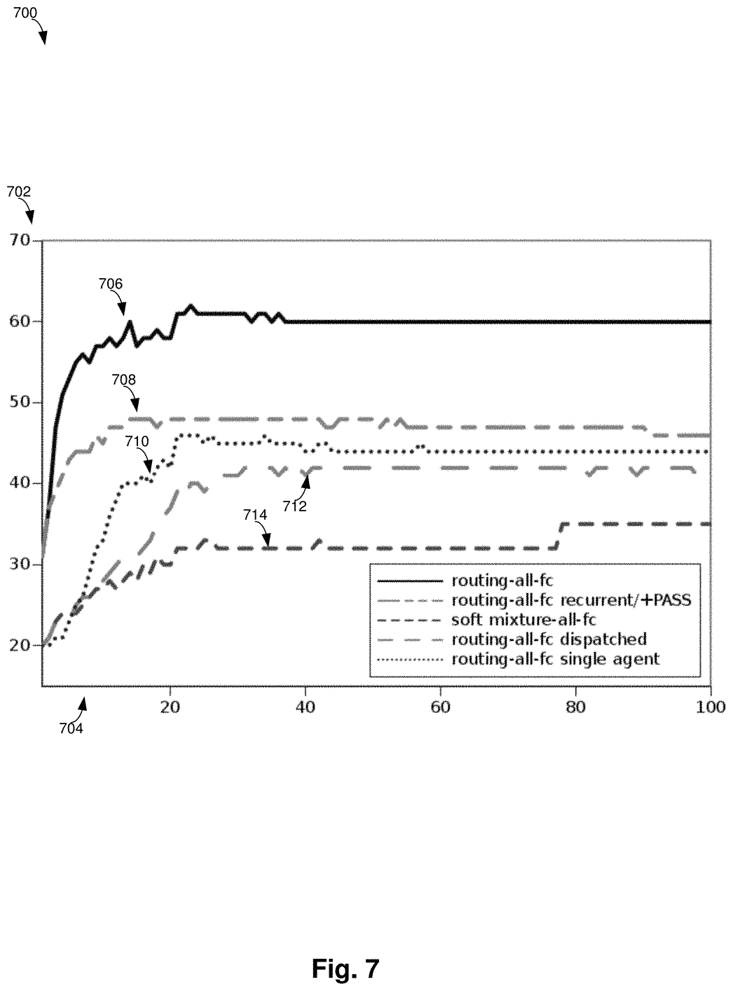

FIG. 7 illustrates an example, non-limiting graph 700 that plots the accuracy of different routing architectures, such as router 310, router 320, or router 330 of FIG. 3. In graph 700, the Y-axis 702 represents accuracy as expressed in a percentage, while the X-axis 704 represents a number of epochs. Results are plotted for routing-all-fc 706, routing-all-fc (recurrent/+PASS) 708, routing-all-fc (single agent) 710, routing-all-fc (dispatched) 712, and soft-mixture-all-fc 714.

In graph 700, a comparison is made for the best performing approach WPL against other routing approaches, including the already introduced reinforce learning: single agent (for which WPL is not applicable, in some examples). These approaches can route the full-connected layers of a SimpleConvNet architecture using the layering approach discussed earlier. To make the next comparison clear, MARL:WPL is renamed to routing-all-fc in FIG. 7 to reflect the fact that it routes all the fully connected layers of a SimpleConvNet architecture, and reinforce learning: single agent can be renamed to routing-all-fc single agent. This can be compared against several other approaches. One approach, routing-all-fc-recurrent/+PASS, can have the same setup as routing-all-fc, without constraining the router to pick from layer 0 function blocks at depth 0, etc. Rather, it can be allowed to choose function block from two of the layers (since the first two routed layers can have identical input and output dimensions; the last is the classification layer). Another approach, soft-mixture-all-fc, generally is a soft version of the router architecture. This soft version can use the same function blocks as the routed version, but can replace the hard selection with a trained softmax attention. A comparison can also be made against the single agent architecture shown in router 310 of FIG. 3 called routing-all-fc single agent and the dispatched architecture shown in router 330 of FIG. 3 called routing-all-fc dispatched. In these example experiments, neither of these approached the performance of the per-task agents. In these example experiments, an approach that exceeds the other approaches is routing-all-fc, the fully routed WPL approach.

Routing-all-fc can then be compared on different domains against cross-stitch networks and two challenging baselines: task specific-1-fc and task specific-all-fc.

Cross-stitch networks can generally be a kind of linear-combination model for multi-task learning. They can maintain one model per task with a shared input layer, and “cross stitch” connection layers, which can allow sharing between tasks. Instead of selecting a single function block in the next layer to route to, a cross-stitch network can route to all the function blocks simultaneously, with the input for a function block i in layer 1 given by a linear combination of the activations that can be computed by all the function blocks of layer l-1. That is: inputₗᵢ=Σⱼ₌₁^{k} wᵢⱼ¹v_{l-1,j}, for learned weights wᵢⱼ¹ and layer l-1 activations v_{l-1,j}. For the present experiments, a cross-stitch layer can be added to each of the routed layers of a SimpleConvNet architecture. An additional comparison can be made to a similar “soft routing” version soft-mixture-fc in graph 700. Soft-routing can use a softmax to normalize the weights used to combine the activations of previous layers and it can share parameters for a given layer so that wᵢ¹=wᵢ^{1′} for all i, i′, l.

The task-specific-1-fc baseline can have a separate last fully connected layer for each task, and can share the rest of the layers for all tasks. The task specific-all-fc baseline can have a separate set of all the fully connected layers for each task. These baseline architectures can allow considerable sharing of parameters, and also can grant the network parameters that are specific to a particular task for each task to avoid interference. However, unlike routing networks, the choice of which parameters are shared for which tasks, and which parameters are specific to a particular task, can be made statically in the architecture, independent of task.

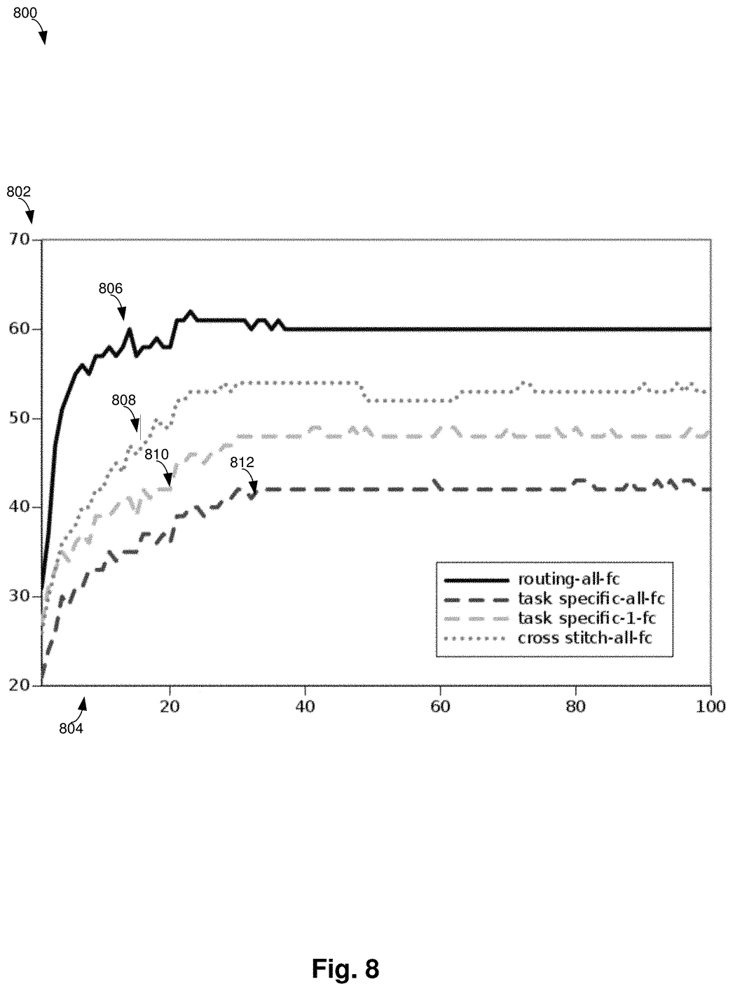

The results are shown in FIGS. 8, 9, and 10. In each experimental case, the routing net routing-all-fc performs consistently better than the cross-stitch networks and the baselines. FIG. 8 illustrates an example, non-limiting graph 800 of performance of a routing network and cross-stitch networks on a CIFAR-MTL dataset. In graph 800, the Y-axis 802 represents accuracy as expressed in a percentage, while the X-axis 804 represents a number of epochs. Results are plotted for routing-all-fc 806, cross-stitch-all-fc 808, task-specific-1-fc 810, and task-specific-all-fc 812. On a CIFAR-MTL dataset in this example, the routing net 806 beats cross-stitch networks 808 by 7% and the next closest baseline task-specific-1-fc 810 by 11%.

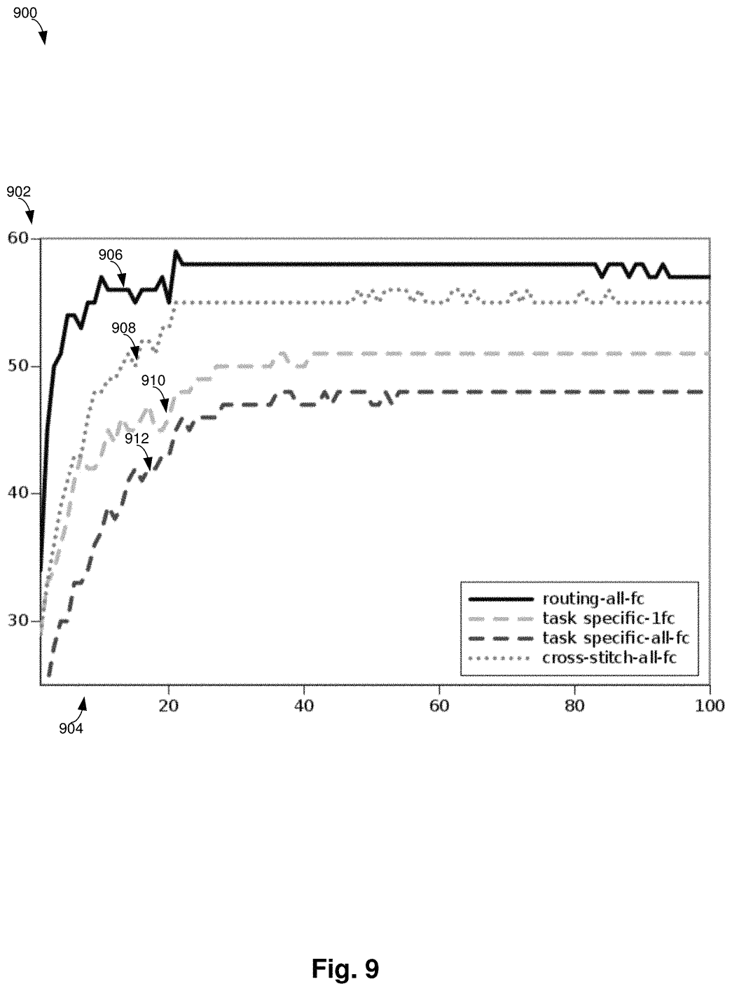

FIG. 9 illustrates an example, non-limiting graph 900 of performance of a routing network and cross-stitch networks on a MIN-MTL dataset. In graph 900, the Y-axis 902 represents accuracy as expressed in a percentage, while the X-axis 904 represents a number of epochs. Results are plotted for routing-all-fc 906, cross-stitch-all-fc 908, task-specific-1-fc 910, and task-specific-all-fc 912. On a MIN-MTL dataset in this example, the routing net 906 beats cross-stitch networks 908 by about 2% and the nearest baseline task-specific-1-fc 910 by about 6%.

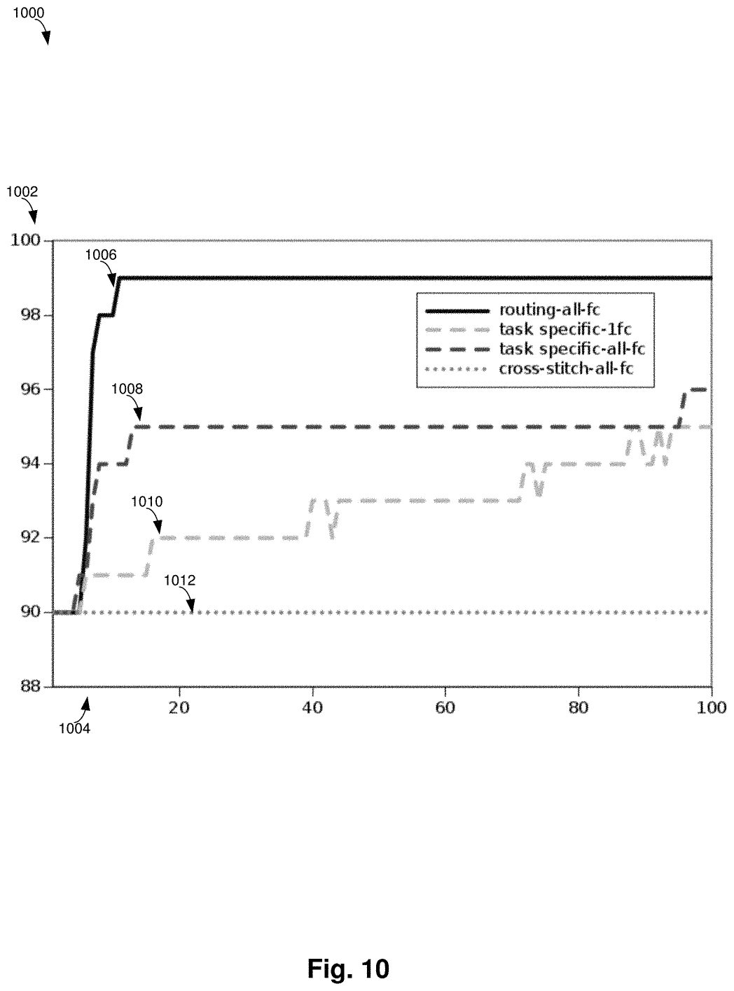

FIG. 10 illustrates an example, non-limiting graph 1000 of performance of a routing network and cross-stitch networks on a MNIST-MTL dataset. In graph 1000, the Y-axis 1002 represents accuracy as expressed in a percentage, while the X-axis 1004 represents a number of epochs. Results are plotted for routing-all-fc 1006, task-specific-all-fc 1008, task-specific-1-fc 1010, and cross-stitch-all-fc 1012. On a MNIST-MTL dataset in this experiment, the random baseline is 90%. Experimentally, routing net 1006 beats the cross-stitch networks 1012 by 9% and the nearest baseline (task-specific-all-fc 1008) by 3%. The soft version also had trouble learning on this dataset in this experiment.

In all these experiments, routing makes a significant difference over both cross-stitch networks and the baselines, and it can be observed that a dynamic policy that learns the function blocks to compose on a per-task basis can yield better accuracy and sharper convergence than simple static sharing baselines or a soft attention approach.

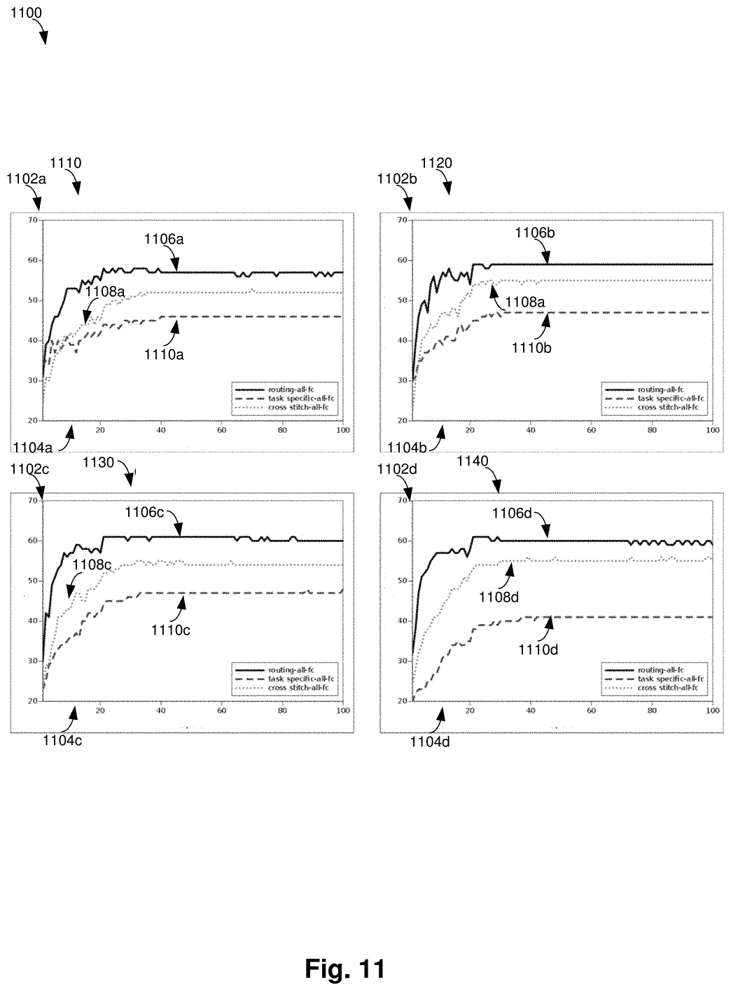

In addition, router training can be much faster. On a CIFAR-MTL dataset, for example, in experiments, training time on a stable compute cluster was reduced from roughly 38 hours to 5.6 hours, an 85% improvement. A set of scaling experiments was conducted to compare the training computation of routing networks and cross-stitch networks trained with 2, 3, 5, and 10 function blocks. The results are shown in FIG. 11, which illustrates four example, non-limiting graphs 1100 of the training computation of routing networks and cross-stitch networks trained with various function blocks. Graphs 1100 comprise graphs 1110 (for the first two tasks), graph 1120 (for the first three tasks), graph 1130 (for the first five tasks), and graph 1140 (for the first 11 tasks). In these graphs, the Y-axis 1102a, 1102b, 1102c, and 1102d represents accuracy measured in percentage, and the X-axis 1104a, 1104b, 1104c, and 1104d represents a number of epochs. Plotted on graph 1110, graph 1120, graph 1130, and graph 1140 are routing-all-fc 1106a, 1106b, 1106c, and 1106d, respectively; task-specific-all-fc 1108a, 1108b, 1108c, and 1108d, respectively; and cross-stitch-all-fc 1110a, 1110b, 1110c, and 1110d, respectively.

In these example experiments, routing networks consistently perform better than cross-stitch networks and the baselines across all these problems. Adding function blocks has no apparent effect on the computation involved in training routing networks on a dataset of a given size. On the other hand, cross-stitch networks can have a soft routing policy that scales computation linearly with the number of function blocks. Because the soft policy can backpropagate through all function blocks, and, in some examples, the hard routing policy only backpropagates through the selected block, the hard policy can much more easily scale to many task learning scenarios that require many diverse types of functional primitives.

Further experiments have been performed on why the multi-agent approach appears to do better than the single-agent, and the policy dynamics are compared for several CIFAR-MTL dataset examples. For these experiments p=0.0 so there is no collaboration reward which might encourage less diversity in the agent choices. In the cases examined, it is found that the single agent often chose just one or two function blocks at each depth, and then routed all tasks to those. In example experimental results, it can appear that there is too little signal available to the agent in the early, random stages, and once a bias is established its decisions suffer from a lack of diversity.

The routing network, on the other hand, can learn a policy that, unlike the baseline static models, can partition the network quite differently for each task, and can also achieve considerable diversity in its choices as can be seen in FIG. 11.

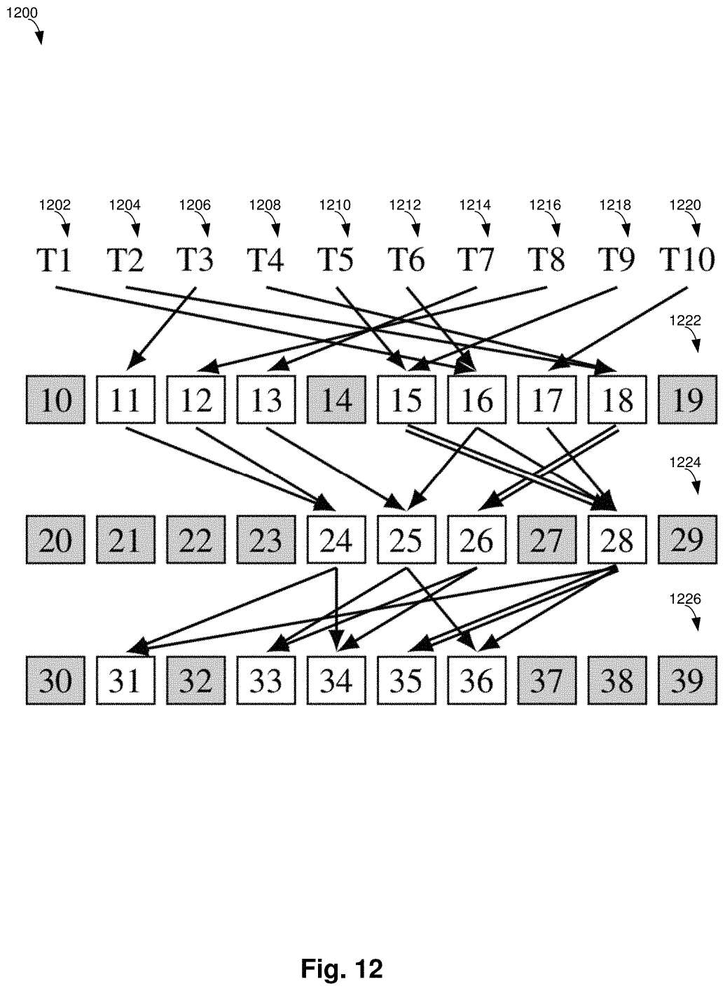

FIG. 12 illustrates an example, non-limiting routing map 1200 for a MNIST-MTL dataset. Routing map 1200 can be produced by a routing network, such as routing network 200. Each task (task 1202, task 1204, task 1206, task 1208, task 1210, task 1212, task 1214, task 1216, task 1218, and task 1220) is labeled at the top and the decisions for each of the three routed layers (layer 1222, layer 1224, and layer 1224) are shown below. It appears that, because the routing network has separate policies for each task, it is less sensitive to a bias for one or two function blocks and each agent learns more independently what works for its assigned task.

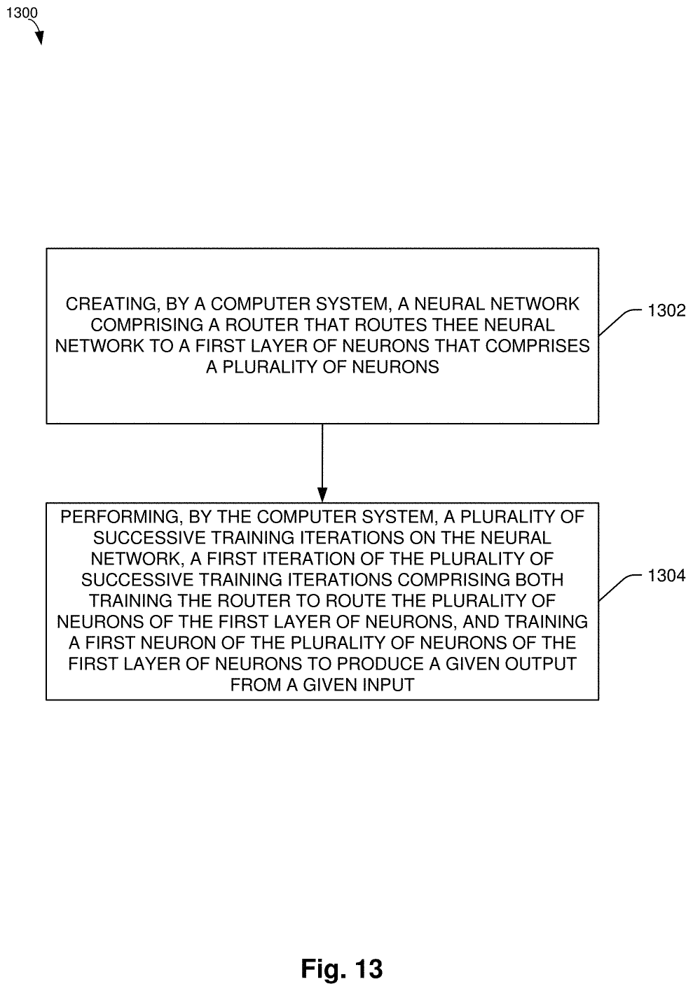

FIG. 13 illustrates a flow diagram of an example, non-limiting computer-implemented method that facilitates efficiently learning from highly-diverse datasets. In some examples, flow diagram 1300 can be implemented by operating environment 1400. It can be appreciated that the operations of flow diagram 1300 can be implemented in a different order than is depicted. It can also be appreciated that the operations of flow diagram 1300 can be implemented in a different order than is depicted.

In non-limiting example embodiments, a computing device (or system) (e.g., computer 1412) is provided comprising one or more processors and one or more memories that stores executable instructions that, when executed by the one or more processors, can facilitate performance of the operations as described herein, including the non-limiting methods as illustrated in the flow diagram of FIG. 13. As a non-limiting example, the one or more processors can facilitate performance of the methods by executing processor-executable instructions to effectuate efficiently learning from highly-diverse datasets.

Operation 1302 depicts creating (e.g., by computer 1412) a neural network comprising a router that routes the neural network to a first layer of neurons that comprises a plurality of neurons.

Operation 1304 depicts performing (e.g., by computer 1412) a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

In some examples, operation 1304 comprises operating (e.g., by computer 1412) on a first data instance and a second data instance, wherein the router is trained to route the first data instance through a first path of the neural network, and wherein the router is trained to route the second data instance through a second path of the neural network.

In some examples, operation 1304 comprises performing (e.g., by computer 1412) a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input. In some examples, the first neuron is trained using stochastic gradient descent and back propagation.

In some examples, operation 1304 comprises performing (e.g., by computer 1412) a second iteration of the plurality of successive training iterations comprising training the router to route among the plurality of neurons of the first layer of neurons, and training the first neuron or a second neuron of the plurality of neurons of the first layer of neurons to produce a second given output from a second given input.

In some examples, operation 1304 comprises performing (e.g., by computer 1412) iterative training on the neural network with a plurality of data pairs, each data pair comprising an input to the neural network, and an intended output from the neural network that corresponds to the input.

In some examples, the router is trained using RL. In some examples, the neural network layers are trained using SGD and back propagation.

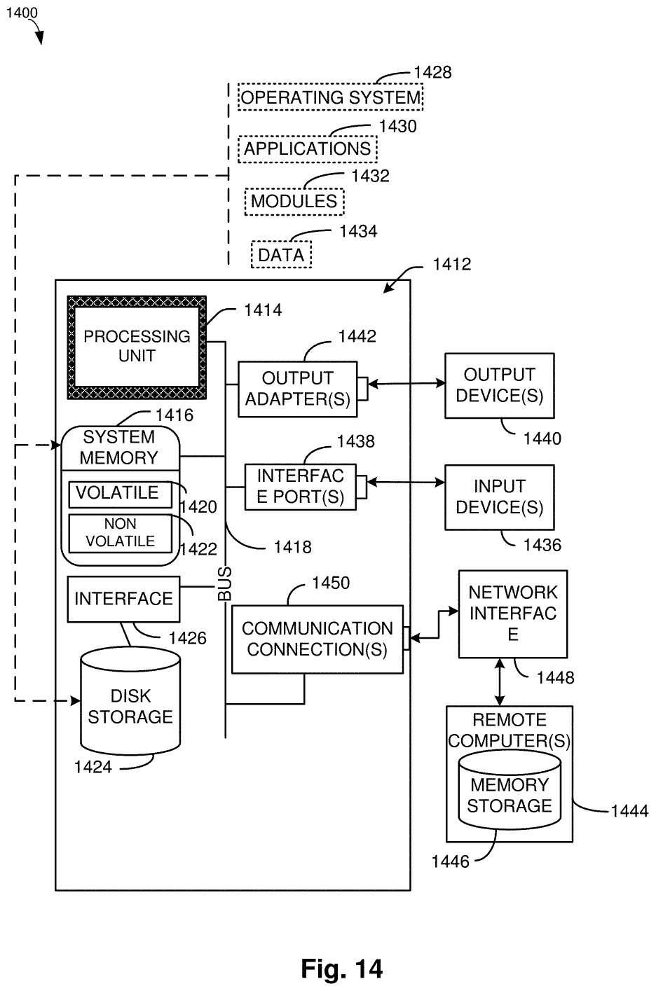

FIG. 14 illustrates a block diagram of an example, non-limiting operating environment in which one or more embodiments described herein can be facilitated.

In order to provide a context for the various aspects of the disclosed subject matter, FIG. 14 as well as the following discussion are intended to provide a general description of a suitable environment in which the various aspects of the disclosed subject matter can be implemented. For example, operating environment 1400 can be used to implement aspects of the example, non-limiting computer-implemented of method FIG. 13. Additionally, in some examples, operating environment can be used to routing network 100 of FIG. 1 or routing network 200 of FIG. 2.

FIG. 14 illustrates a block diagram of an example, non-limiting operating environment in which one or more embodiments described herein can be facilitated. Repetitive description of like elements employed in other embodiments described herein is omitted for sake of brevity. With reference to FIG. 14, a suitable operating environment 1400 for implementing various aspects of the present techniques can also include a computer 1412. The computer 1412 can also include a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414. The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1494), and Small Computer Systems Interface (SCSI).

The system memory 1416 can also include volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1420 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1412 can also include removable/non-removable, volatile/non-volatile computer storage media. FIG. 14 illustrates, for example, a disk storage 1424. Disk storage 1424 can also include, but is not limited to, devices like a magnetic disk drive, floppy disk drive, tape drive, Jaz drive, Zip drive, LS-100 drive, flash memory card, or memory stick. The disk storage 1424 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1424 to the system bus 1418, a removable or non-removable interface is typically used, such as interface 1426. FIG. 14 also depicts software that acts as an intermediary between users and the basic computer resources described in the suitable operating environment 1400. Such software can also include, for example, an operating system 1428. Operating system 1428, which can be stored on disk storage 1424, acts to control and allocate resources of the computer 1412.

System applications 1430 take advantage of the management of resources by operating system 1428 through program modules 1432 and program data 1434, e.g., stored either in system memory 1416 or on disk storage 1424. It is to be appreciated that the present techniques can be implemented with various operating systems or combinations of operating systems. A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port can be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a computer, a server, a router, a network PC, a workstation, a microprocessor based appliance, a peer device or other common network node and the like, and typically can also include many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1450 refers to the hardware/software employed to connect the network interface 1448 to the system bus 1418. While communication connection 1450 is shown for illustrative clarity inside computer 1412, it can also be external to computer 1412. The hardware/software for connection to the network interface 1448 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that the present techniques also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of the present techniques can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. As used herein, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing the present techniques, but one of ordinary skill in the art can recognize that many further combinations and permutations of the present techniques are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
a neural network component that creates a neural network comprising a router that routes the neural network to a first layer of neurons that comprises a plurality of neurons; and
a training component that performs a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

2. The system of claim 1, wherein the training component further performs a second iteration of the plurality of successive training iterations comprising training the router to route among the plurality of neurons of the first layer of neurons, and training the first neuron or a second neuron of the plurality of neurons of the first layer of neurons to produce a second given output from a second given input.

3. The system of claim 1, wherein the training component performs iterative training on the neural network with a plurality of data pairs, each data pair comprising an input to the neural network, and an intended output from the neural network that corresponds to the input.

4. The system of claim 1, wherein the neural network component operates on a first data instance and a second data instance, wherein the router is trained to route the first data instance through a first path of the neural network, and wherein the router is trained to route the second data instance through a second path of the neural network.

5. The system of claim 1, wherein the training component trains the router using reinforcement learning.

6. The system of claim 1, wherein the training component trains a plurality of neural network layers that comprise the first layer of neurons using stochastic gradient descent and back propagation.

7. The system of claim 1, wherein the training component trains the first neuron using stochastic gradient descent and back propagation.

8. A computer-implemented method, comprising:
creating, by a system operatively coupled to a processor, a neural network comprising a router that routes the neural network to a first layer of neurons that comprises a plurality of neurons; and
performing, by the system, a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

9. The computer-implemented method of claim 8, further comprising:
performing, by the system, a second iteration of the plurality of successive training iterations comprising training the router to route among the plurality of neurons of the first layer of neurons, and training the first neuron or a second neuron of the plurality of neurons of the first layer of neurons to produce a second given output from a second given input.

10. The computer-implemented method of claim 8, further comprising:
performing, by the system, iterative training on the neural network with a plurality of data pairs, each data pair comprising an input to the neural network, and an intended output from the neural network that corresponds to the input.

11. The computer-implemented method of claim 8, further comprising:
operating, by the system, on a first data and a second data, wherein the router is trained to route the first data through a first path of the neural network, and wherein the router is trained to route the second data through a second path of the neural network.

12. The computer-implemented method of claim 8, further comprising:
training, by the system, the router using reinforcement learning.

13. The computer-implemented method of claim 8, further comprising:
training, by the system, the router using stochastic gradient descent and back propagation.

14. The computer-implemented method of claim 8, further comprising:
training, by the system, the first neuron using stochastic gradient descent and back propagation.

15. A computer program product for training a neural network, the computer program product comprising a computer readable storage medium having program instructions embodied therewith, the program instructions executable by a processor to cause the processor to:
create, by the processor, the neural network comprising a router that routes the neural network to a first layer of neurons that comprises a plurality of neurons; and
perform, by the processor, a plurality of successive training iterations on the neural network, a first iteration of the plurality of successive training iterations comprising both training the router to route among the plurality of neurons of the first layer of neurons, and training a first neuron of the plurality of neurons of the first layer of neurons to produce a given output from a given input.

16. The computer program product of claim 15, wherein the program instructions are further executable by the processor to cause the processor to:
perform, by the processor, a second iteration of the plurality of successive training iterations comprising training the router to route among the plurality of neurons of the first layer of neurons, and training the first neuron or a second neuron of the plurality of neurons of the first layer of neurons to produce a second given output from a second given input.

17. The computer program product of claim 15, wherein the program instructions are further executable by the processor to cause the processor to:
perform, by the processor, iterative training on the neural network with a plurality of data pairs, each data pair comprising an input to the neural network, and an intended output from the neural network that corresponds to the input.

18. The computer program product of claim 15, wherein the program instructions are further executable by the processor to cause the processor to:
operate, by the processor, on a first data and a second data, wherein the router is trained to route the first data through a first path of the neural network, and wherein the router is trained to route the second data through a second path of the neural network.

19. The computer program product of claim 15, wherein the program instructions are further executable by the processor to cause the processor to:
train, by the processor, the router using reinforcement learning.

20. The computer program product of claim 15, wherein the program instructions are further executable by the processor to cause the processor to:
train, by the processor, a plurality of network layers that comprises the first layer of neurons using stochastic gradient descent and back propagation.
